(19) United States
(12) Patent Application Publication
(10) Pub. No.: US 2025/0227820 A1
(43) Pub. Date: Jul. 10, 2025

(54) COOKTOP LIGHTING SYSTEM

(71) Applicant: Prizer Painter Stove Works Inc., Blandon, PA (US)

(72) Inventors: Stéphane LOMP, GAMBSHEIM (FR); Kevin KIEFFER, SPINEA (IT)

(21) Appl. No.: 19/092,877

(22) Filed: Mar. 27, 2025

Related U.S. Application Data
(63) Continuation of application No. PCT/US2024/044524, filed on Aug. 29, 2024.
(60) Provisional application No. 63/535,477, filed on Aug. 30, 2023.

(51) Int. Cl. H05B 6/12

(52) U.S. Cl. CPC H05B 6/1218

(57) ABSTRACT

Some systems, devices and methods detailed herein can include a cooktop system with one or more light elements positioned at each of the heating elements of the cooktop system. The light elements include a plurality of power indication stages that correspond to and display a plurality of power stages of each of the heating elements.

### CROSS-REFERENCE TO RELATED APPLICATION

This application is a continuation of PCT Application No. PCT/US2024/044524 filed Aug. 29, 2024, which claims the benefit of U.S. Provisional Application No. 63/535,477, filed Aug. 30, 2023, the contents of each are incorporated by reference herein.

### TECHNICAL FIELD

This disclosure describes systems, devices, and methods for cooktop lighting.

### BACKGROUND

Heating elements are used in cooktop systems to facilitate heating of the cooktop surface and items placed on the cooktop surface. Some cooktop systems use display elements or knob positions to indicate a power level of various heating elements of the cooktop surface.

### SUMMARY

This disclosure describes systems, devices, and methods for cooktop, for example, lighting that indicates power levels of heating elements at various locations on a cooktop. In particular implementations, the systems, devices, and methods described herein can include a cooktop equipped with one or more heating elements and light elements positioned at each of the one or more heating elements to illuminate a power level of each of the one or more heating elements. Optionally, the cooktop can include one or more control elements that facilitate the activation and control of the power levels (e.g., amount of heat) provided at each of the heating elements. Each of the light elements are responsive to the power levels at the respective heating element the light element is positioned at. The light elements include power indication stages that illuminate to display the power level at each heating element. Additionally, the light elements are visible to a user of the cooktop (e.g., while one or more items of cookware are on the cooktop), and the light elements illuminate the power level for each of the heating elements of the cooktop.

Among other benefits, some systems and methods described herein can advantageously provide a more efficient, intuitive, and user-friendly approach to indicating power levels are various locations on a cooktop. Additionally, some embodiments described in more detail below can achieve a visible and adjustable solution that facilitates clear and intuitive guidance and information to a user regarding power levels at one or more heating elements of the cooktop that would otherwise not be visible to a user at the heating element.

Some embodiments described herein include The cooktop system includes a cooktop including one or more heating elements and one or more control elements that control power delivered to each of the one or more heating elements, the control elements are adjustable to provide a plurality of power levels to each of the one or more heating elements; and one or more light elements positioned at each of the one or more heating elements, the one or more light elements include a plurality of power indication stages that correspond to the plurality of power levels; where, responsive to an adjustment of at least one of the control elements to select a power level of at least one of the one or more heating elements, activating the light element positioned at the at least one heating element to illuminate a power indication stage that corresponds to the power level of the heating element.

Such a system can include one or more of the following optional features. The cooktop system where the one or more light elements are light bars. The power indication stages incrementally grow outwardly from a center portion of each of the light bars responsive to adjustments at the one or more control elements to increase the power level supplied to one or more of the heating elements. The power indication stages incrementally retract inwardly towards the center portion from outer portions of each of the light bars responsive to adjustments at the one or more control elements to decrease the power level supplied to one or more of the heating elements. The adjustment of the power level decreases the power level of one of the activated heating elements; and the adjusting the power indication stage of the light element includes incrementally retracting an illuminated area of the light element inwardly towards the center portion from outer portions of each of the light bars responsive to adjustments at the one or more control elements to decrease the power level supplied to one or more of the heating elements. The light bars are horizontal light bars positioned visually below each of the one or more heating elements. The light bars are vertical light bars positioned visually on one side of each of the one or more heating elements. The light bars are curved light bars positioned visually below each of the one or more heating elements. Each of the one or more light elements includes four power indication stages. Each of the one or more light elements includes a timer. Each of the one or more light elements is individually responsive to one of the control elements. The one or more heating elements are induction heating elements. The one or more light elements are visible to a user of cooktop system when one or more items of cookware are positioned on the cooktop system.

Some embodiments described herein include a method of displaying a power level of a cooktop. The method of displaying also includes positioning one or more light elements at each of one or more heating elements of a cooktop, the light elements include a plurality of power indication stages that correspond to a plurality of power levels of each of the one or more heating elements; activating at least one of the heating elements by actuating a control element, illuminating the one or more light elements at each of the activated heating elements, adjusting a power level of one of the activated heating elements, and adjusting the power indication stage of the light element at the activated heating element to correspond to the power level.

Such a method can include one or more of the following optional features. The method where the one or more light elements are light bars. The adjustment of the power level increases the power level of one of the activated heating elements; and the adjusting the power indication stage of the light element includes incrementally growing an illuminated area of the light element outwardly from a center portion of the light bar responsive to adjustments at the one or more control elements to increase the power level supplied to one or more of the heating elements. The adjustment of the power level increases the power level of one of the activated heating elements, and the adjusting the power indication stage of the light element includes incrementally growing an illuminated area of the light element outwardly from a first side of the light bar responsive to adjustments at the one or more control elements to increase the power level supplied to one or more of the heating elements. The adjustment of the power level decreases the power level of one of the activated heating elements, and the adjusting the power indication stage of the light element includes incrementally retracting an illuminated area of the light element inwardly towards the first side and away from a second side of each of the light bars responsive to adjustments at the one or more control elements to decrease the power level supplied to one or more of the heating elements. Each of the one or more light elements is individually responsive to one of the control elements. The one or more heating elements are induction heating elements.

Particular implementations can, in certain instances, realize one or more of the following advantages. First, some embodiments described herein provide a visible solution that positions light elements at the heating elements to facilitate guidance and information to a user about which heating elements are active and what power level each heating element has. Second, particular solutions described herein offer a readily visible approach that advantageously displays and adjusts to display power levels of each heating element both while one or more items of cookware are present on the heating element and while one or more items of cookware are not present on the heating element. Third, some embodiments described herein provide adjustable light elements that illustrate power indication levels that correspond to the power level of the heating element that would otherwise not be visible to a user at the heating element.

The details of one or more implementations are set forth in the accompanying drawings and the description below. Other features, objects, and advantages will be apparent from the description and drawings, and from the claims.

### DESCRIPTION OF DRAWINGS

FIG. 1 shows a perspective view of an example cooktop system, consistent with some embodiments of this disclosure.

FIG. 2A shows an example light element at a first power indication stage, consistent with embodiments of this disclosure.

FIG. 2B shows the example light element of FIG. 2A at a second power indication stage.

FIG. 2C shows the example light element of FIG. 2A at a third power indication stage.

FIG. 2D shows the example light element of FIG. 2A at a fourth power indication stage.

FIG. 3A shows an example light element at a first power indication stage, consistent with embodiments of this disclosure.

FIG. 3B shows the example light element of FIG. 3A at a second power indication stage.

FIG. 3C shows the example light element of FIG. 3A at a third power indication stage.

FIG. 3D shows the example light element of FIG. 3A at a fourth power indication stage.

FIG. 4A shows an example light element, consistent with embodiments of this disclosure.

FIG. 4B shows another example light element, consistent with embodiments of this disclosure.

FIG. 4C shows another example light element, consistent with embodiments of this disclosure.

FIG. 5 shows a top view of an example cooktop system during operation of the system.

FIG. 6 shows a top view of the cooktop system of FIG. 5 at another operational step.

FIG. 7 shows a top view of the cooktop system of FIG. 5 at another operational step.

FIG. 8 shows a top view of the cooktop system of FIG. 5 at another operational step.

FIG. 9 shows a top view of the cooktop system of FIG. 5 at another operational step.

FIG. 10 shows a top view of the cooktop system of FIG. 5 at another operational step.

Like reference symbols in the various drawings indicate like elements.

### DETAILED DESCRIPTION

This document describes cooktop systems that include light elements to indicate power levels at one or more heating elements. The cooktop systems described herein can include light elements that are implemented in the cooktop system illuminating the power level of each of the heating elements of the cooktop system at the heating element. The shape and the arrangement of the light elements in the cooktop systems described herein significantly improve the visibility of the power levels of the heating elements of the cooktop system. Optionally, the cooktop systems described herein can include induction coils that are implemented in cooktop systems for heating one or more cookware devices. The adjustable light elements illustrate power indication levels that correspond to the power level of the heating element that would otherwise not be visible to a user at the heating element.

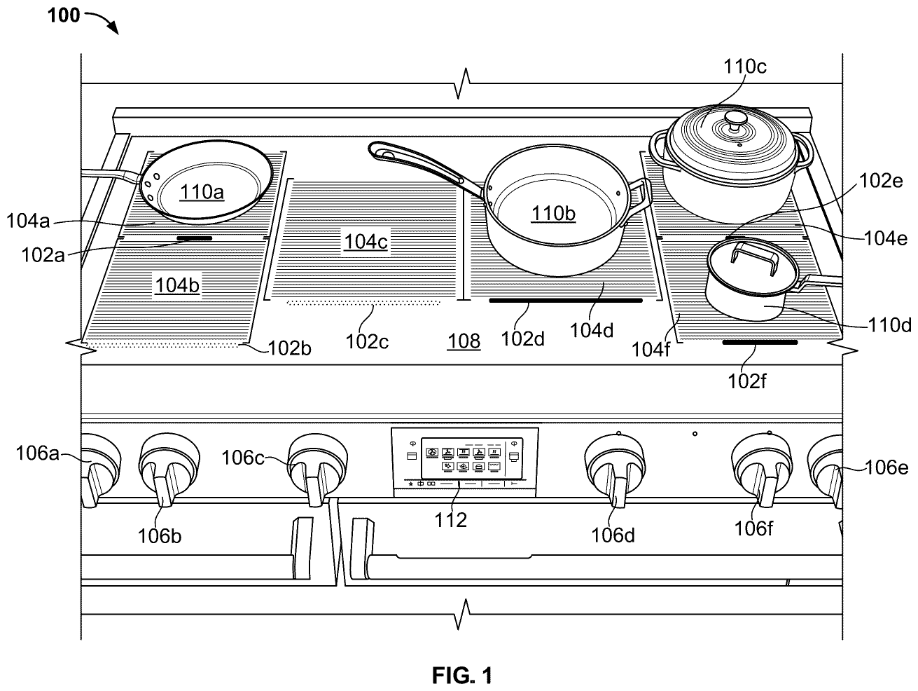

Referring to FIG. 1, some embodiments of a cooktop system 100 can include light elements 102a-f that illuminate active heating elements and the power at each respective heating element of the cooktop system. In this embodiment, the system 100 can include light elements 102a-f, heating elements 104a-f, control elements 106a-f, a cooktop surface 108, and cookware 110a-d. In some embodiments, the cooktop system 100 facilitates the heating, cooking, and preparation of food. For example, the cooktop surface 108 and the heating elements 104a-f support cookware 110a-d (e.g., pots, pans) on the cooktop surface 108 where heat from the heating elements 104a-f is transferred to the cookware 110a-d to facilitate the heating, cooking, and preparation of food.

The cooktop system 100 includes heating elements 104a-f arranged on the cooktop surface 108. In some embodiments, the heating elements 104a-f are induction heating elements. In some embodiments, the heating elements 104a-f are at least one of induction heating elements, electric heating elements, downdraft heating elements, and/or gas heating elements. In the illustrated embodiment, the heating elements 104a-f are arranged such that six heating elements are spaced apart on the cooktop surface 108. The illustrated embodiments includes heating elements 104a, 104b, 104e, and 104f positioned along an outer area of the cooktop surface 108 and with the heating elements 104c and 104d positioned between the heating elements 104a, 104b and 104e and 104f. In some embodiments, each of the heating elements 104a-f are the same size. In some embodiments, the heating elements 104a-f can include different sizes. For example, the heating elements 104a, 104b, 104e, and 104f can be the same size as each other and can be smaller than the heating elements 104c and 104d. The heating elements 104a, 104b, 104e, and 104f can be aligned and/or stacked vertically along the length of the cooktop surface 108. The heating elements 104c and 140d can be positioned side-by-side in a central region of the cooktop surface 108. While the illustrated embodiment includes six heating elements 104a-f, some embodiments include one heating element, two heating elements, three heating elements, four heating elements, five heating elements, and seven or more heating elements. In some embodiments, the heating elements 104a-f can include other numbers of heating elements and other arrangements of heating elements such as a single row of heating elements, two rows of heating elements, one heating element for the cooktop surface 108, among other arrangements.

The cooktop system 100 includes light elements 102a-f positioned at each heating element 104a-f. The light elements 102a-f facilitate a visual indication of the active heating elements (e.g., heating elements 104a, 104d. 104e, and 104f) and the power level of each active heating element. Inactive heating elements (e.g., heating elements 104b and 104c) also have light elements 102b and 102c, and the light elements 102b and 102c are inactive or off. While the user is operating the cooktop system 100 (e.g., the user is positioned on the side of the control elements 106a-f), the light elements 102a-f are visible to the user. In the illustrated embodiment, the light elements 102a-f are positioned visually below each heating element 104a-f, where a user of the cooktop system 100 operates the cooktop system from the side of the cooktop system 100 that the control elements 106a-f are positioned. In some embodiments, the light elements 102a-f can be positioned along a visual side (instead of along a visual bottom). For example, the light elements 102a-f can be positioned on the right or left side of the heating elements 104a-d. In some embodiments, the light elements 102a and 102b can be positioned along a right side of each of the heating elements 104a and b, the light elements 102c and 102d can be positioned on the right or left side of the heating elements 104c and 104d, and the light elements 102e and 102f can be positioned on the left side of each of the heating elements 104e and 140f.

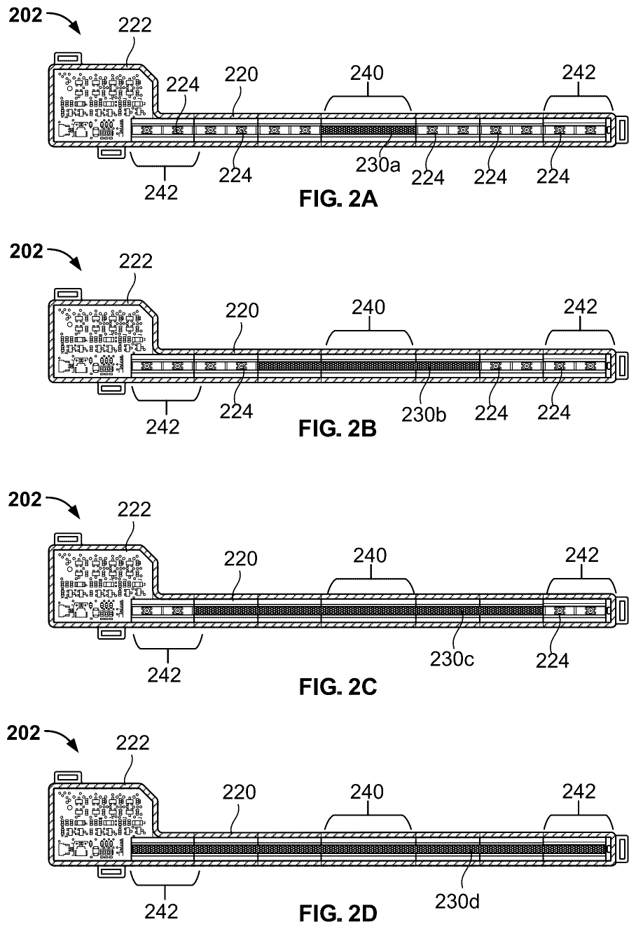

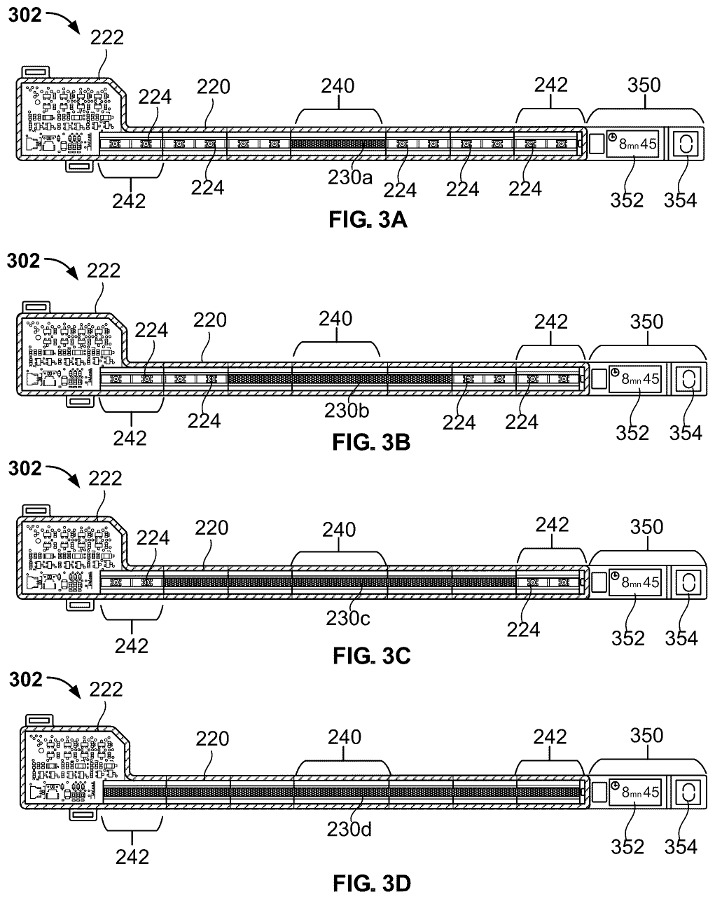

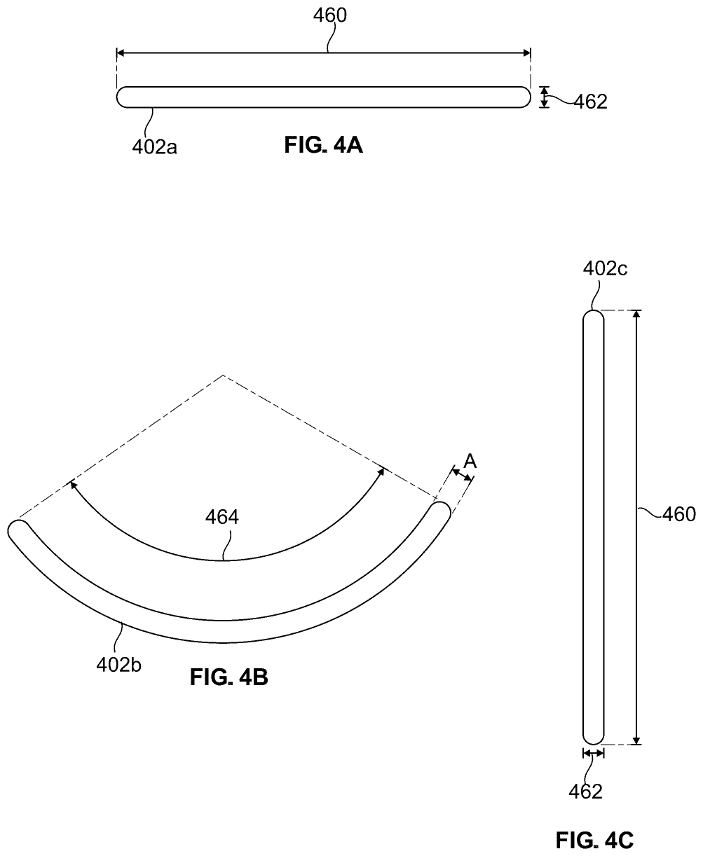

Still referring to FIG. 1, the light elements 102a-f include a plurality of power indication stages (see e.g., FIGS. 2A-3D) that correspond to the plurality of power levels of the heating elements 104a-f. For example, the light elements 102a-f are light bars that expand in length as the power level of the heating element is increased. The light bar can contract in length as the power level of the heating element is reduced. In some embodiments, the light elements 102a-f are horizontal light bars positioned visually below each of the one or more heating elements 104a-f (see also FIG. 4A). In some embodiments, the light elements 102a-f are vertical light bars positioned visually on one side of each of the one or more heating elements 104a-f (see, e.g., FIG. 4C). In some embodiments, the light elements 102a-f are curved light bars positioned visually below each of the one or more heating elements 104a-f (see e.g., FIG. 4B).

The cooktop system 100 includes the control elements 106a-f that facilitate activation, deactivation, and power control of each of the heating elements 104a-f. The control elements 106a-f are adjustable to provide a plurality of power levels to each of the one or more heating elements 104a-f. In the illustrated embodiment, the control elements 106a-f are knobs that are adjustable (e.g., turn-able, rotatable) by a user to select a power level for each of the heating elements 104a-f. The control elements 106a-f can include knobs, buttons, dials, sliders, touch screens, or other control elements that facilitate the activation, deactivation, and power control of each of the heating elements 104a-f. Each control element 106a-f is independently operable to control each respective heating element 104a-f. Physical interaction with each control element 106a-f activates and determines the power level at each heating element 104a-f and activates the light element 102a-f associated with each respective heating element 104a-f and control element 106a-f.

The light elements 102a-f display the active heating elements 104a-d and the power level at each heating element 104a-f. Responsive to an adjustment of at least one of the control elements 106a-f to select a power level of at least one of the one or more heating elements 104a-f, the light element 102a-f positioned at the heating element 104a-f is activated. For example, FIG. 1 illustrates the light element 102d is activated and illuminates that the heating element 104d is active and has a high power level (e.g., as selected by the control element 106d). FIG. 1 illustrates an example where heating element 104c is inactive, and the light element 102c is also inactive. FIG. 1 further illustrates light element 102a activated and indicating that the heating element 104a is active and at a low power. Each of the light elements 102a-f is individually responsive to one of the control elements 106a-f.

In some embodiments, the cooktop system 100 includes a display 112. The display 112 can be optional to the system 100. The display 112 can include additional information and controls for the cooktop system 100 such as timers, bridging selection, controls for an oven, and display of power levels, among other display features.

Referring to FIGS. 2A-2D, an example light element 202 is shown removed from a cooktop system (e.g., cooktop system 100). The light element 202 is shown at various power indication stages that illuminate a power level at an associated heating element of the cooktop system. In some embodiments, the light element 202 can be any of the light elements 102a-f of the cooktop system 100. The light element 202 includes a light portion 220 and a control portion 222. The control portion 222 can include a circuit board that has one or more processors, a memory, and stores instructions that control the light portion 220. In some embodiments, the control portion 222 directly communicates with a control element (e.g., control elements 106a-f). For example, the control portion 222 can independently operate the light portion 220 from a control system of the cooktop system. In some embodiments, the control portion 222 communicates with a controller of the cooktop system. For example, the controller of the cooktop system can be connected to the control elements and facilitate communication between the control elements (e.g., control elements 106a-f) and the control portion 222.

The light portion 220 includes a plurality of light sources 224 that can be separately activated to illuminate the power indication stages of the light element 202. For example, the light sources 224 are light emitting diodes (LEDS) that independently activated to illuminate the power indication stages 230a-d. In some embodiments, the power indication stages 230a-d incrementally grow outwardly from a center portion 240 of the light element 202 responsive to adjustments at the one or more control elements to increase the power level supplied to one or more of the heating elements. The power indication stages 230a-d incrementally retract inwardly towards the center portion 240 from outer portions 242 of each of the light elements 202 responsive to adjustments at the one or more control elements to decrease the power level supplied to one or more of the heating elements. In some embodiments, the power indication stages can grow from left to right, from right to left, from the top down (e.g., with a vertically oriented light element), from the bottom up (e.g., with a vertically oriented light element). For example, the power indication stages can incrementally grow outwardly from left to right or from right to left. The power indication stages can start at one of the outer portions 242 (e.g., a first side) and incrementally grow across the center portion 240, and to the outer portion 242 (e.g., a second side) on the opposite side of the light element.

In some embodiments, the light element 202 includes four power indication stages 230a-230d and an off stage. The off stage of the light element 202 includes deactivating the light sources 224 so that the light element 202 is off. The off stage corresponds to a heating element that is also off. The first power indication stage 230a (see FIG. 2A) can indicate a low power at a heating element, and can occupy the center portion 240 of the light element 202. For example, the light sources 224 within the center portion 240 are activated to illuminate the first power indication stage 230a. The second power indication stage 230b (see FIG. 2B) can indicate a medium-low power at a heating element, and can occupy the center portion 240 and additional light sources on both sides of the center portion 240 of the light element 202. For example, the light sources 224 within the center portion 240 and selected light sources (e.g., symmetrical on both sides of the center portion 240) are activated to illuminate the second power indication stage 230b. The third power indication stage 230c (see FIG. 2C) can indicate a medium-high power at a heating element, and can occupy the center portion 240 and additional light sources on both sides of the center portion 240 up to and not including the outer portions 242 of the light element 202. For example, the light sources 224 within the center portion 240 and selected light sources (e.g., symmetrical on both sides of the center portion 240 up to the outer portions 242) are activated to illuminate the third power indication stage 230c. The fourth power indication stage 230d (see FIG. 2D) can indicate a high power at a heating element, and can occupy the entire light portion 220 including the outer portions 242 of the light element 202. For example, the light sources 224 along entire light portion 220 including the outer portions 242 are activated to illuminate the fourth power indication stage 230d.

In some embodiments, the light element 202 includes four power indication stages 230a-d. The light element 202 can include one power indication stage (e.g., on/off), two power indication stages, three power indication stages, four power indication stages, five power indication stages, six power indication stages, seven power indication stages, eight power indication stages, nine power indication stages, ten power indication stages, or more than ten power indication stages. In some embodiments, the cooktop system (e.g., cooktop system 100) can include various light elements that have the same number of power indication stages (e.g., each light element has four power indication stages). In some embodiments, the cooktop system (e.g., cooktop system 100) can include various light elements that have different numbers of power indication stages. For example, larger heating elements can include additional power indication stages that smaller heating elements do not include (e.g., large heating elements include six power indication stages and small heating elements include three power indication stages).

Referring to FIGS. 3A-3D, an example light element 302 is illustrated. The light element 302 shares the features of the light element 202 and like features are given like numbers. Light element 302 also includes a display portion 350. The display portion 350 can include advanced functions that can be a timer 352 and a bridge display 354. The timer 352 can display a timer that is associated with the heating element that the light element 302 is positioned at. For example, the timer 352 can display a time that the heating element has been active, a cooking timer, a timer associated with the current power level, or other timers. The timer 352 can display numerical digits aligned with the light element 302 and the light sources 224. The bridge display 354 can display whether or not a bridge mode is activated. For example, a bridge mode can include a combination of two or more heating elements that are controlled together. The bridge display 354 illustrates if the bridge mode is active or inactive. The bridge display 354 is aligned with light element 302 and the light sources 224. The light element 302 is shown at various power indication stages that illuminate a power level at an associated heating element of the cooktop system. In some embodiments, the light element 302 can be any of the light elements 102a-f of the cooktop system 100 and/or light element 202.

Referring to FIGS. 4A-4C, the light elements 404a-c can include various shapes and orientations. The light elements 404a-c can be implemented as any of the light elements 102a-f, 202, and 302. For example, the light element 404a is a horizontal light bar that has a length 460 and a width 462. The light element 404a can include rounded end portions, and the length 460 can be greater than the width 462 to create a rounded-end light bar. The light element 404c can share the features of the light element 404a, and can be oriented vertically (e.g., 90-degrees from the horizontal orientation) of the light element 404a. The light element 402b has an arced profile that includes the width 462. The arced profile of the light element 402b follows an arc path that has an arc length 464.

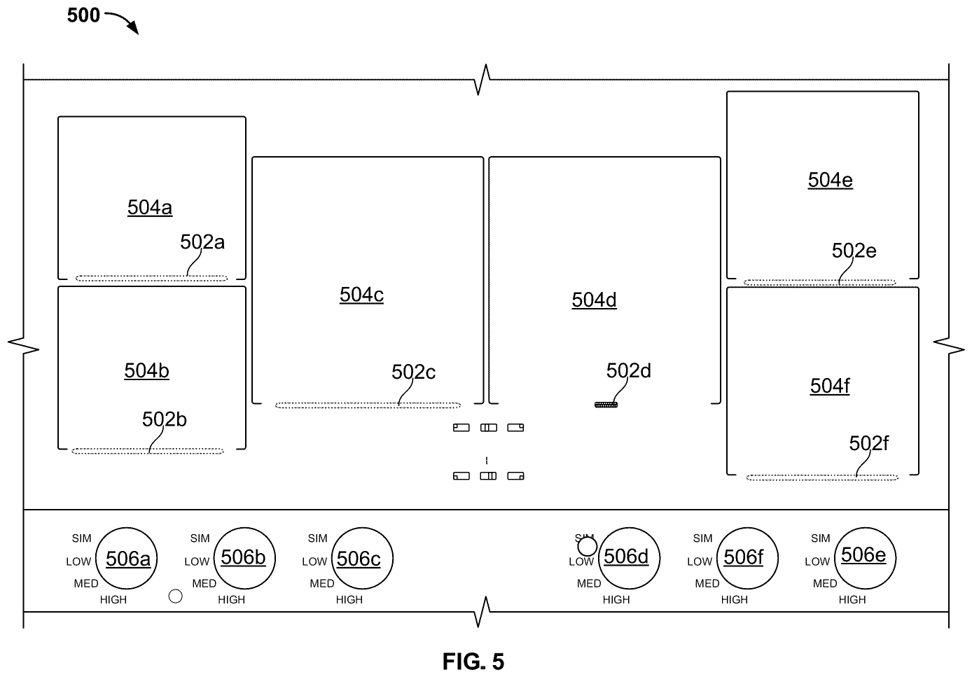

Referring to FIGS. 5-10, exemplary variations of a cooktop system 500 with light elements are shown. The cooktop system 500 can share features with the cooktop system 100, and can include light elements 502a-502f that share features with any of the light elements 102a-f, 202, 302, and 402a-c. The heating elements 504a-f can share the features with heating elements 104a-f.

Referring to FIG. 5, heating element 504d is activated. For example, a user activates heating element 504d by actuating the control element 506d. The light element 502d positioned at the heating element 504d illuminates the power indication level associated with the heating element 504d. As illustrated, the user selected a simmer heat setting at control element 506d, and the light element 502d illuminates the power indication level associated with the simmer heat setting. The other heat elements 504a-c and 504e-f are not activated and the light elements 502a-c and 502e-f are off.

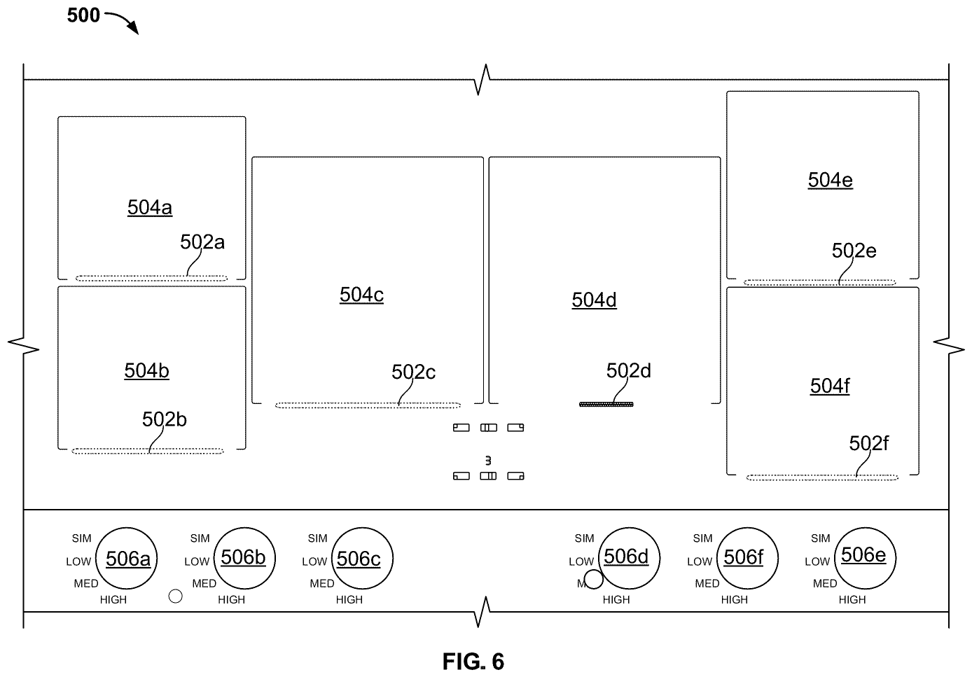

Referring to FIG. 6, heating element 504d is turned to a higher setting than FIG. 5. For example, a user turns the heating element 504d up by actuating the control element 506d to a low heat setting. The light element 502d positioned at the heating element 504d illuminates the power indication level associated with the heating element 504d (e.g., larger than in FIG. 5). As illustrated, the user selected a low heat setting at control element 506d, and the light element 502d illuminates the power indication level associated with the low heat setting.

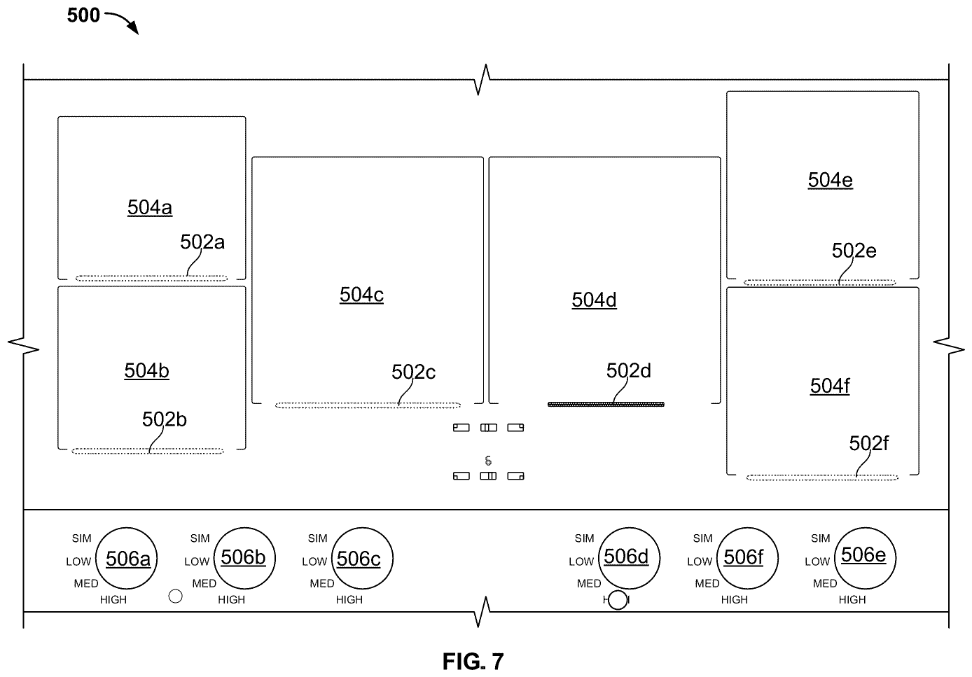

Referring to FIG. 7, heating element 504d is turned to a higher setting than FIG. 6. For example, a user turns the heating element 504d up by actuating the control element 506d to a medium heat setting. The light element 502d positioned at the heating element 504d illuminates the power indication level associated with the heating element 504d (e.g., larger than in FIGS. 5 and 6). As illustrated, the user selected a medium heat setting at control element 506d, and the light element 502d illuminates the power indication level associated with the medium heat setting.

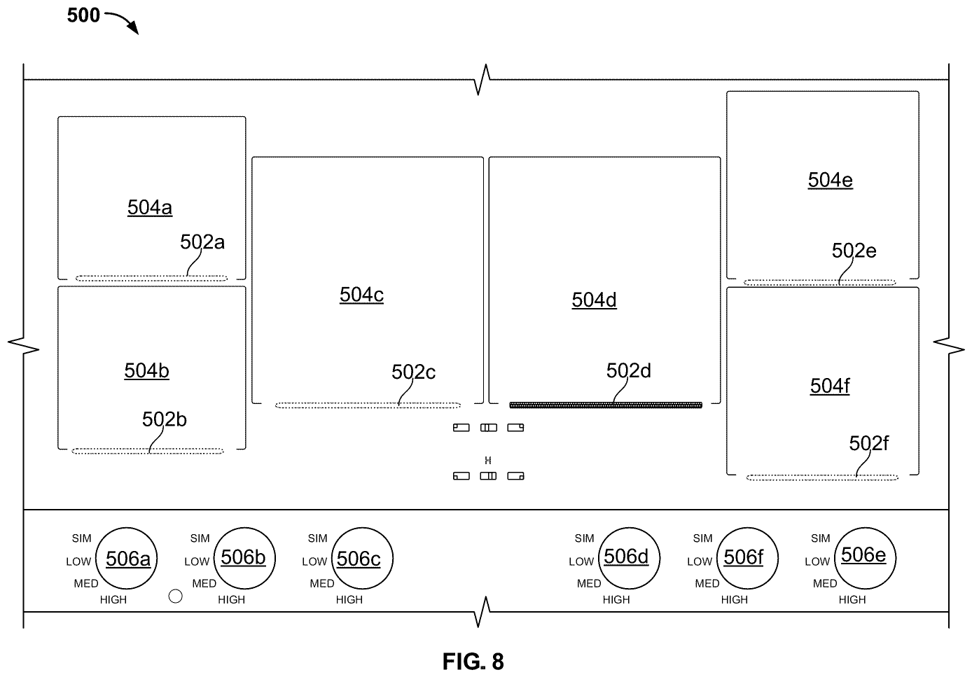

Referring to FIG. 8, heating element 504d is turned to a higher setting than FIG.6. For example, a user turns the heating element 504d up by actuating the control element 506d to a high heat setting. The light element 502d positioned at the heating element 504d illuminates the power indication level associated with the heating element 504d (e.g., larger than in FIGS. 5, 6, and 7). As illustrated, the user selected a high heat setting at control element 506d, and the light element 502d illuminates the power indication level associated with the high heat setting.

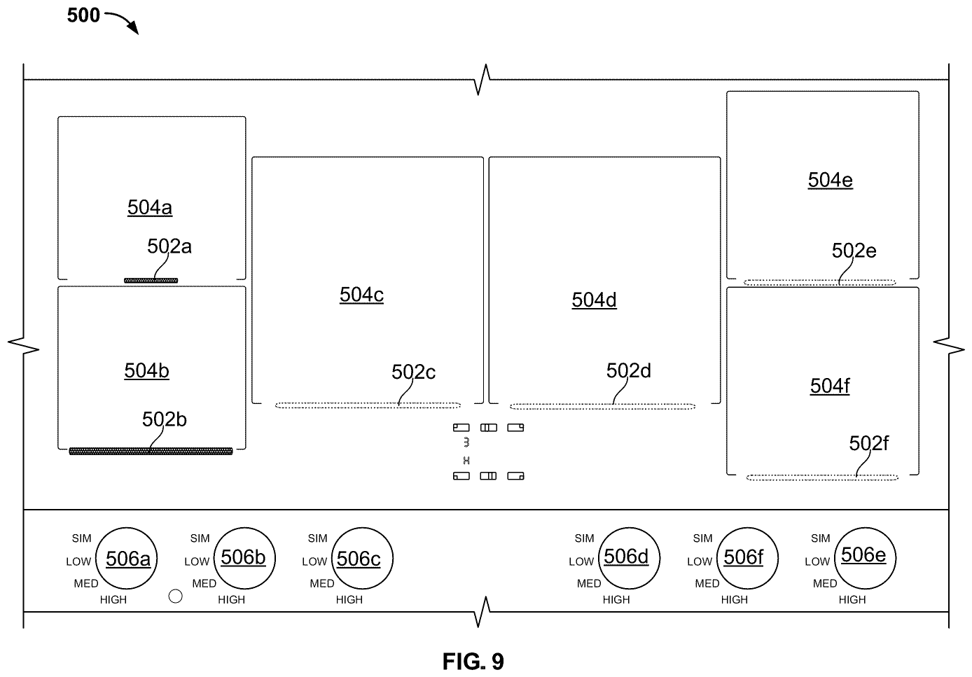

Referring to FIG. 9, the heating element 504d is turned off and the light element 502d is turned off. Heating elements 504a and 504b are activated. For example, a user activates heating elements 504a and 504b by actuating the control elements 506a and 506b. The light elements 502a and 502b positioned at the respective heating elements 504a and 504b illuminate the power indication level associated with the each heating element 504a and 504b. As illustrated, the user selected a low heat setting at control element 506a, and the light element 502a illuminates the power indication level associated with the low heat setting. The user selected a high heat setting at control element 506b, and the light element 502b illuminates the power indication level associated with the high heat setting. The other heat elements 504c-f are not activated and the light elements 502c-f are off.

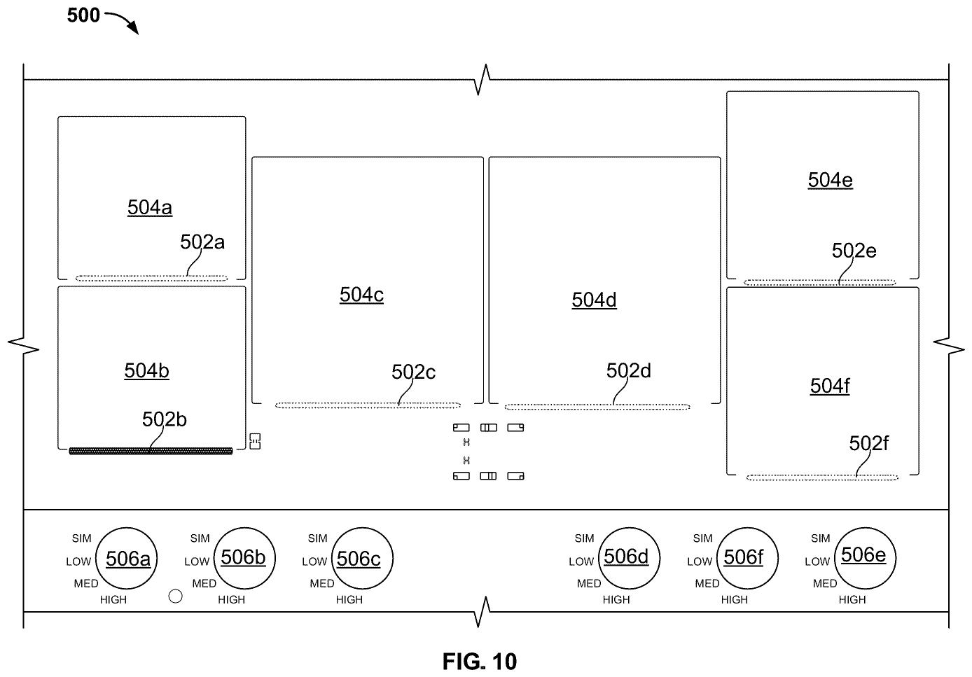

Referring to FIG. 10, a bridge mode for heating elements 504a and 504b is illustrated. The user selects to bridge heating elements 504a and 504b to operate the heating elements 504a and 504b at the same heat setting. The bridge mode facilitates uniform heating of a larger cookware that extends onto all or a portion of both heating elements 504a and 504b. In the bridge mode, the light element 502a is deactivated and the light element 502b remains activated and reflects the power level for the bridged heating elements 504a and 504b.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

Accordingly, other implementations are within the scope of the following claims.

What is claimed is:

1. A cooktop system, comprising:
a cooktop including one or more heating elements and one or more control elements that control power delivered to each of the one or more heating elements, the control elements are adjustable to provide a plurality of power levels to each of the one or more heating elements; and
one or more light elements positioned at each of the one or more heating elements, the one or more light elements include a plurality of power indication stages that correspond to the plurality of power levels;
wherein, responsive to an adjustment of at least one of the control elements to select a power level of at least one of the one or more heating elements, activating the light element positioned at the at least one heating element to illuminate a power indication stage that corresponds to the power level of the heating element.

2. The cooktop system of claim 1, wherein the one or more light elements are light bars.

3. The cooktop system of claim 1, wherein the power indication stages incrementally grow outwardly from a center portion of each of the light bars responsive to adjustments at the one or more control elements to increase the power level supplied to one or more of the heating elements.

4. The cooktop system of claim 3, wherein the power indication stages incrementally retract inwardly towards the center portion from outer portions of each of the light bars responsive to adjustments at the one or more control elements to decrease the power level supplied to one or more of the heating elements.

5. The cooktop system of claim 2, wherein the light bars are horizontal light bars positioned visually below each of the one or more heating elements.

6. The cooktop system of claim 2, wherein the light bars are vertical light bars positioned visually on one side of each of the one or more heating elements.

7. The cooktop system of claim 2, wherein the light bars are curved light bars positioned visually below each of the one or more heating elements.

8. The cooktop system of claim 1, wherein each of the one or more light elements includes four power indication stages.

9. The cooktop system of claim 8, wherein each of the one or more light elements includes a timer.

10. The cooktop system of claim 1, wherein each of the one or more light elements is individually responsive to one of the control elements.

11. The cooktop system of claim 1, wherein the one or more heating elements are induction heating elements.

12. The cooktop system of claim 1, wherein the one or more light elements are visible to a user of cooktop system when one or more items of cookware are positioned on the cooktop system.

13. A method of displaying a power level of a cooktop, the method comprising:
positioning one or more light elements at each of one or more heating elements of a cooktop, the light elements include a plurality of power indication stages that correspond to a plurality of power levels of each of the one or more heating elements;
activating at least one of the heating elements by actuating a control element;
illuminating the one or more light elements at each of the activated heating elements;
adjusting a power level of one of the activated heating elements; and
adjusting the power indication stage of the light element at the activated heating element to correspond to the power level.

14. The method of claim 13, wherein the one or more light elements are light bars.

15. The method of claim 14, wherein the adjustment of the power level increases the power level of one of the activated heating elements; and
the adjusting the power indication stage of the light element includes incrementally growing an illuminated area of the light element outwardly from a center portion of the light bar responsive to adjustments at the one or more control elements to increase the power level supplied to one or more of the heating elements.

16. The method of claim 13, wherein the adjustment of the power level decreases the power level of one of the activated heating elements; and
the adjusting the power indication stage of the light element includes incrementally retracting an illuminated area of the light element inwardly towards the center portion from outer portions of each of the light bars responsive to adjustments at the one or more control elements to decrease the power level supplied to one or more of the heating elements.

17. The method of claim 14, wherein the adjustment of the power level increases the power level of one of the activated heating elements; and
the adjusting the power indication stage of the light element includes incrementally growing an illuminated area of the light element outwardly from a first side of the light bar responsive to adjustments at the one or more control elements to increase the power level supplied to one or more of the heating elements.

18. The method of claim 17, wherein the adjustment of the power level decreases the power level of one of the activated heating elements; and
the adjusting the power indication stage of the light element includes incrementally retracting an illuminated area of the light element inwardly towards the first side and away from a second side of each of the light bars responsive to adjustments at the one or more control elements to decrease the power level supplied to one or more of the heating elements.

19. The method of claim 13, wherein each of the one or more light elements is individually responsive to one of the control elements.

20. The method of claim 13, wherein the one or more heating elements are induction heating elements.

21. The method of claim 13, wherein the one or more light elements are visible to a user of cooktop system when one or more items of cookware are positioned on the cooktop system.
